(19) United States
(12) Patent Application Publication
(10) Pub. No.: US 2011/0044584 A1
(43) Pub. Date: Feb. 24, 2011

(54) OPTICAL FIBER CONNECTION ASSEMBLY

(75) Inventor: Gary Helstern, Newtown, CT (US)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: DIBA INDUSTRIES, INC., Danbury, CT (US)

(21) Appl. No.: 12/543,573

(22) Filed: Aug. 19, 2009

(51) Int. Cl. G02B 6/38

(52) U.S. Cl. 385/56

(57) ABSTRACT

Optical fiber connection assemblies respectively comprising a torque fitting and a fitting connector are described. The torque fitting comprises a torque-limiting body portion, a threaded body portion with a mechanical thread, and an optical fiber accommodating channel. The fitting connector, meanwhile, comprises threaded body portion with a mechanical thread complimentary to that of the torque fitting. The respective threaded body portions releasably connect via the complimentary mechanical threads by rotating the threaded body portion of the torque fitting along the threaded body portion of the fitting connector the such that optical fibers accommodated by the respective channels are aligned along an optical path in a proximity sufficient to permit transmission of light across the optical fibers with achievement of the threshold level of torque applied in rotating the torque fitting in the compressive direction of rotation along the threaded body portion of the fitting connector. Additional embodiments are disclosed and claimed.

### CROSS-REFERENCE TO RELATED APPLICATIONS

This application is related to, but does not continue from or claim priority to, the currently pending U.S. patent application Ser. No. 12/045,071 (DIB 0102 I3/36029.31), filed Mar. 10, 2008, which is a continuation-in-part of abandoned U.S. patent application Ser. No. 11/382,127 (DIB 0102 IA), filed May 8, 2006, which claims the benefit of, and is a continuation-in-part of, abandoned U.S. Non-Provisional application Ser. No. 11/380,501 (DIB 0102 PA), filed Apr. 27, 2006. In addition, this application is related to, but does not continue from or claim priority to, the currently pending U.S. patent application Ser. No. 12/039,039 (DIB 0115 PA), filed Feb. 28, 2008.

### BACKGROUND

Generally, connections between optical fibers require that the optical fibers be precisely aligned to avoid substantial transmission loss of light transmitted across the optical fibers. More particularly, precise alignment along an optical path and sufficient proximity of a transmitting end of an optical fiber and a receiving end of another optical fiber generally is necessary to minimize transmission losses as light travels over the optical fibers. Transmission loss generally is attributed to misalignment of optical fibers, damage to ends of the optical fibers, and/or the presence of a gap between the transmitting and receiving ends of the optical fibers. Connectors used to connect optical fibers frequently cause or further exacerbate these conditions leading to greater transmission loss.

Generally, only light that is transmitted into and received by an optical core of the receiving end of an optical fiber propagates through the receiving optical fiber, whereas a remainder of the light emanating from the transmitting end of an optical fiber and not received by the optical core of the receiving fiber becomes the loss of the light transmitted by the optical fibers. Therefore, gaps between the transmitting and receiving ends of the optical fibers should be minimized as the gaps generally increase light insertion loss and light return loss (i.e., transmission loss). With the presence of a significant gap between the optical fibers, an emerging cone of light from the transmitting end spills over the optical core of the receiving fiber and is lost. In addition, an air gap between the optical fibers may cause a reflection when the transmitted light encounters the change in refractive index from the glass of the optical fiber to the air in the gap. This reflection generally amounts to about 5% of the transmitted light in typical flat polished optical fiber connectors, typically resulting in transmission loss of greater than 0.3 decibels per kilometer.

There are many different ways to provide a connection between optical fibers, with one of the most prominent being a threaded connector. Eliminating, or at least substantially minimizing, an air gap between transmitting and receiving ends of optical fibers with a threaded connector requires a precise control of torque applied in connecting the ends of the optical fibers. If the threaded connector is over-tightened, then the ends of the optical fibers may be damaged or become misaligned. If, however, the threaded connector is not sufficiently tightened, or under-tightened, then a significant air gap between the ends of the optical fibers may be present and increase light transmission losses.

### SUMMARY OF THE INVENTION

It is against the above background that embodiments of the present invention provide an optical fiber connection assembly with a torque-limiting feature to facilitate the connecting of ends of the optical fibers through assuring proper alignment and sufficient proximity of the transmitting and receiving ends of the optical fibers so as to minimize light transmission loss.

Embodiments of the present invention generally relate to an optical fiber connection assembly comprising a torque fitting and a fitting connector. The optical fiber connection assembly aligns optical fibers along an optical path in a proximity sufficient to permit transmission of light across the optical fibers with achievement of a threshold level of torque applied in releasably connecting the torque fitting to the fitting connector. More particularly, embodiments of the present invention generally align optical fibers along an optical path in a proximity sufficient to permit transmission of light across the optical fibers with minimal transmission loss. A torque-limiting configuration of the torque fitting prevents an over-tightening and avoids an under-tightening of the torque fitting releasably connected to the fitting connector. Embodiments of the present invention also generally relates to methods of aligning optical fibers with a torque fitting and a fitting connector for a transmission of light across the optical fibers.

In accordance with one embodiment, a method of aligning at least two optical fibers for a transmission of light with a torque fitting and a fitting connector comprises providing a torque fitting comprising a threaded body portion, a torque-limiting body portion, and an optical fiber accommodating channel. The threaded body portion and the torque-limiting body portion are arranged substantially concentrically along a longitudinal axis of the torque fitting, while the channel of the torque fitting is oriented along the longitudinal axis of the torque fitting and defines a cross-sectional area sufficient to accommodate an optical fiber. The threaded body portion of the torque fitting comprises a mechanical thread defining a compressive direction of rotation and a decompressive direction of rotation. The torque-limiting body portion and the threaded body portion of the torque fitting are operable such that, below a threshold level of torque applied to the torque-limiting body portion, rotation of the torque-limiting body portion in the compressive direction of rotation forces the threaded body portion of the torque fitting to rotate with the torque-limiting body portion, above the threshold level of torque applied to the torque-limiting body portion, rotation of the torque-limiting body portion in the compressive direction of rotation fails to force the threaded body portion to rotate with the torque-limiting body portion, and rotation of the torque-limiting body portion in the decompressive direction of rotation forces the threaded body portion to rotate with the torque-limiting body portion. The method further comprises providing a fitting connector comprising a threaded body portion and an optical fiber accommodating channel. The channel of the fitting connector is oriented along a longitudinal axis of the fitting connector and defines a cross-sectional area sufficient to accommodate an optical fiber, while the threaded body portion of the fitting connector comprises a mechanical thread complimentary to the mechanical thread of the threaded body portion of the torque fitting. In addition, the method comprises inserting an optical fiber at least partially into each of the respective channels of the torque fitting and the fitting connector and releasably connecting the respective threaded body portions of the torque fitting and the fitting connector via the complimentary mechanical threads by rotating the threaded body portion of the torque fitting along the threaded body portion of the fitting connector such that an end of the optical fiber accommodated by the channel of the fitting connector and an end of the optical fiber accommodated by the channel of the torque fitting are aligned along an optical path in a proximity sufficient to permit transmission of light across the optical fibers with achievement of the threshold level of torque applied in rotating the torque fitting in the compressive direction of rotation along the threaded body portion of the fitting connector.

In accordance with another embodiment, an optical fiber connection assembly comprises a torque fitting and a fitting connector. The torque fitting comprises a threaded body portion, a torque-limiting body portion, and an optical fiber accommodating channel. The threaded body portion and the torque-limiting body portion are arranged substantially concentrically along a longitudinal axis of the torque fitting. The channel of the torque fitting is oriented along the longitudinal axis of the torque fitting and defines a cross-sectional area sufficient to accommodate an optical fiber. The threaded body portion of the torque fitting comprises a mechanical thread defining a compressive direction of rotation and a decompressive direction of rotation. The torque-limiting body portion and the threaded body portion of the torque fitting are operable such that, below a threshold level of torque applied to the torque-limiting body portion, rotation of the torque-limiting body portion in the compressive direction of rotation forces the threaded body portion of the torque fitting to rotate with the torque-limiting body portion, above the threshold level of torque applied to the torque-limiting body portion, rotation of the torque-limiting body portion in the compressive direction of rotation fails to force the threaded body portion to rotate with the torque-limiting body portion, and rotation of the torque-limiting body portion in the decompressive direction of rotation forces the threaded body portion to rotate with the torque-limiting body portion. The fitting connector comprises a threaded body portion and an optical fiber accommodating channel. The channel of the fitting connector is oriented along a longitudinal axis of the fitting connector and defines a cross-sectional area sufficient to accommodate an optical fiber. The threaded body portion of the fitting connector comprises a mechanical thread complimentary to the mechanical thread of the threaded body portion of the torque fitting. The respective threaded body portions of the torque fitting and the fitting connector are releasably connectable via the complimentary mechanical threads by rotating the threaded body portion of the torque fitting along the threaded body portion of the fitting connector the such that an optical fiber accommodated by the channel of the torque fitting is aligned with an optical fiber accommodated by the channel of the fitting connector along an optical path in a proximity sufficient to permit transmission of light across the optical fibers with achievement of the threshold level of torque applied in rotating the torque fitting in the compressive direction of rotation along the threaded body portion of the fitting connector.

In accordance with yet another embodiment, an optical fiber connection assembly comprises a torque fitting and a fitting connector. The torque fitting comprises a threaded body portion, a torque-limiting body portion, and an optical fiber accommodating channel. The threaded body portion and the torque-limiting body portion are arranged substantially concentrically along a longitudinal axis of the fitting. The channel of the torque fitting is oriented along the longitudinal axis of the torque fitting and defines a cross-sectional area sufficient to accommodate an optical fiber. One of the threaded body portion or the torque-limiting body portion comprises a lever, while the other of the threaded body portion or the torque-limiting body portion comprises an abutment. The lever comprises a first arresting surface and a yielding surface and the abutment comprises a second arresting surface and an engaging surface. The lever and the abutment are configured such that the yielding surface of the lever and the engaging surface of the abutment engage when torque below a threshold level is applied in rotating the torque-limiting body portion in a compressive direction of rotation. The lever and the abutment are further configured such that the engaging surface contacts the yielding surface and the lever deflects an amount sufficient to allow the lever to bypass the abutment when torque above the threshold level is applied in rotating the torque-limiting body portion in the compressive direction of rotation. The deflection of the lever by the abutment causes the lever to flex toward the body portion of the torque fitting comprising the lever and away from the body portion of the torque fitting comprising the abutment. The lever is configured with a degree of elasticity sufficient to enable repetitive flexion of the lever. The lever and the abutment are further configured such that the first and second arresting surfaces engage when torque is applied in rotating the torque-limiting body portion in a decompressive direction of rotation such that the torque-limiting body portion forces the threaded body portion of the torque fitting to rotate with the torque-limiting body portion. The fitting connector comprises a threaded body portion and an optical fiber accommodating channel. The channel of the fitting connector is oriented along a longitudinal axis of the fitting connector and defines a cross-sectional area sufficient to accommodate an optical fiber. The threaded body portion of the fitting connector comprises a mechanical thread complimentary to the mechanical thread of the threaded body portion of the torque fitting. The respective threaded body portions of the torque fitting and the fitting connector are releasably connectable via the complimentary mechanical threads by rotating the threaded body portion of the torque fitting along the threaded body portion of the fitting connector the such that an optical fiber accommodated by the channel of the torque fitting is aligned with an optical fiber accommodated by the channel of the fitting connector along an optical path in a proximity sufficient to permit transmission of light across the optical fibers with achievement of the threshold level of torque applied in rotating the torque fitting in the compressive direction of rotation along the threaded body portion of the fitting connector.

### BRIEF DESCRIPTION OF THE SEVERAL VIEWS OF THE DRAWINGS

The following detailed description of specific embodiments can be best understood when read in conjunction with the following drawings, where like structure is indicated with like reference numerals and in which:

FIG. 1 is an illustration of a cross-sectional view of an optical fiber connection assembly with a torque fitting and a fitting connector according to one embodiment;

FIG. 2 is an illustration of a view of a torque fitting wherein an engagement between an abutment and a lever forces a threaded body portion of the torque fitting to rotate in a compressive direction of rotation with a torque-limiting body portion of the torque fitting according to another embodiment;

FIG. 3 is an illustration of a view of a torque fitting wherein a deflection of the lever by the abutment fails to force the threaded body portion to rotate in a compressive direction of rotation with the torque-limiting body portion according to another embodiment;

FIG. 4 is an illustration of a view of a torque fitting wherein an engagement between the abutment and the lever forces the threaded body portion to rotate in a decompressive direction of rotation with the torque-limiting body portion according to another embodiment;

FIG. 5 is an illustration of a cross-sectional view of an optical fiber connection assembly with a torque fitting releasably connected to a fitting connector according to another embodiment;

FIG. 6 is an illustration of a cross-sectional view of an optical fiber connection assembly with two torque fittings releasably connected to opposing ends of a fitting connector according to another embodiment; and

FIG. 7 is an illustration of a cross-sectional view of an optical fiber connection assembly with a torque fitting releasably connected to a fitting connector according to another embodiment.

The embodiments set forth in the drawings are illustrative in nature and are not intended to be limiting of the embodiments defined by the claims. Moreover, individual aspects of the drawings and the embodiments will be more fully apparent and understood in view of the detailed description.

### DETAILED DESCRIPTION

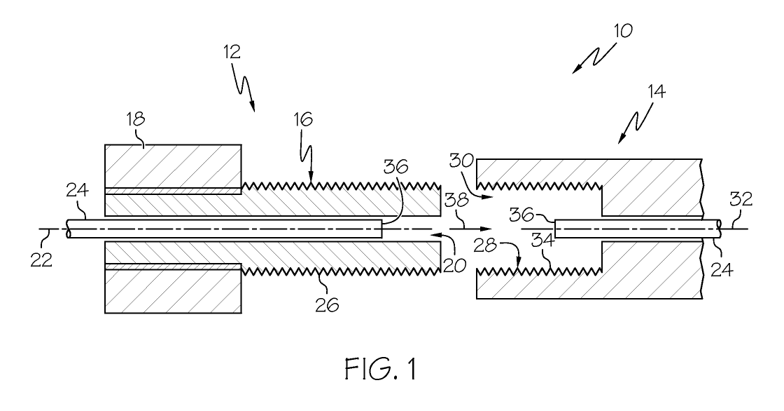

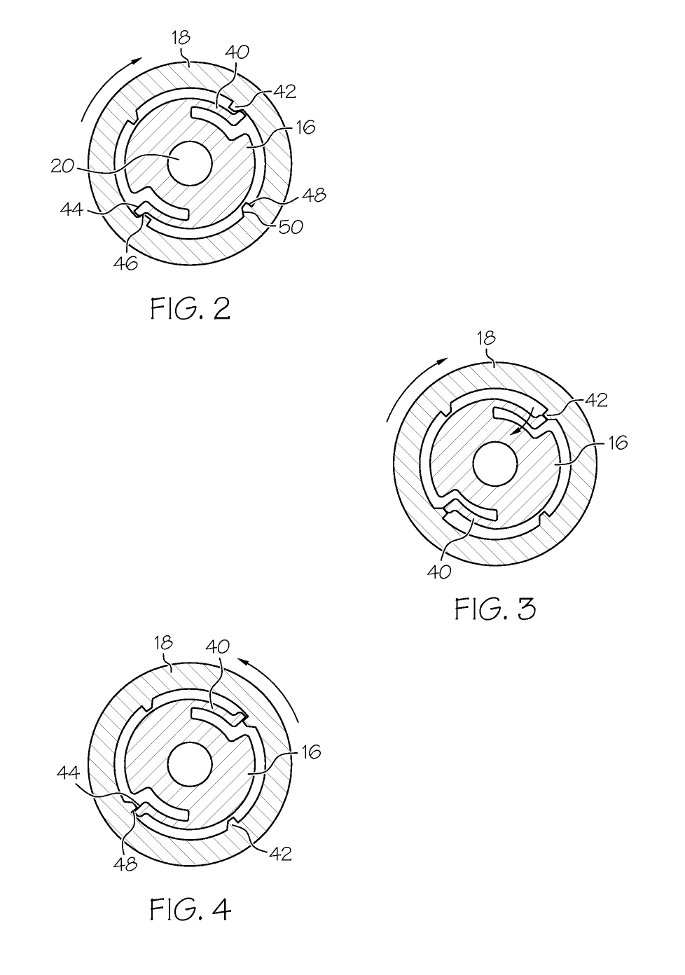

The optical fiber connection assembly is configured to align ends of optical fibers along an optical path for a transmission of light across the optical fibers. Referring initially to FIG. 1, the optical fiber connection assembly 10 comprises a torque fitting 12 and a fitting connector 14. The torque fitting 12 comprises a threaded body portion 16, a torque-limiting body portion 18, and an optical fiber accommodating channel 20. The threaded body portion 16 and the torque-limiting body portion 18 are arranged substantially concentrically along a longitudinal axis 22 of the torque fitting 12. The channel 20 is oriented along this longitudinal axis 22, extends through opposite ends of the torque fitting 12, and defines a cross-sectional area sufficient to accommodate an optical fiber 24. The threaded body portion 16 comprises a mechanical thread 26. The mechanical thread 26 defines a compressive direction of rotation, as shown by the clockwise directional arrow depicted in FIGS. 2 and 3, and a decompressive direction of rotation, as shown by the counter-clockwise directional arrow depicted in FIG. 4.

As shown in FIGS. 1 and 5-7, the fitting connector 14 comprises a threaded body portion 28 and an optical fiber accommodating channel 30. The channel 30 is oriented along a longitudinal axis 32, extends through opposite ends of the fitting connector 14, and defines a cross-sectional area sufficient to accommodate an optical fiber 24. The threaded body portion 28 of the fitting connector 14 comprises a mechanical thread 34 complimentary to the mechanical thread 26 of the threaded body portion 16 of the torque fitting 12.

The respective threaded body portions 16, 28 of the torque fitting 12 and the fitting connector 14 may be releasably connected via the complimentary mechanical threads 26, 34, as shown in FIGS. 1 and 5-7. The respective threaded body portions 16, 28 may be releasably connected by rotating the threaded body portion 16 of the torque fitting 12 along the threaded body 28 of the fitting connector 14. More particularly, the torque-limiting body portion 18 and the threaded body portion 16 of the toque fitting 12 generally are operable such that when torque below a threshold level is applied to the torque-limiting body portion 18, rotation of the torque-limiting body portion 18 in the compressive direction of rotation forces the threaded body portion 16 to rotate with the torque-limiting body portion 18 along the threaded body portion 28 of the fitting connector 14.

When, however, torque above the threshold level is applied to the torque-limiting body portion 18, rotation of the torque-limiting body portion 18 in the compressive direction of rotation fails to force the threaded body portion 16 of the torque fitting 12 to rotate with the torque-limiting body portion 18. Here, as torque above the threshold level is applied, only the torque-limiting body portion 18 of the torque fitting 12 continues to rotate in the compressive direction of rotation, while the threaded body portion 16 of the torque fitting 12 fails to rotate along the threaded body portion 28 of the fitting connector 14, thereby precluding any further tightening of the releasable connection between the torque fitting 12 and the fitting connector 14.

Further, the torque-limiting body portion 18 and the threaded body portion 16 of the torque fitting 12 generally are operable such that rotation of the torque-limiting body portion 18 in the decompressive direction of rotation forces the threaded body portion 16 to rotate with the torque-limiting body portion 18, regardless of the level of torque applied to the torque-limiting body portion 18. Therefore, the threaded boy portion 16 and the torque-limiting body portion 18 both rotate together in the decompressive direction of rotation along the threaded body portion 28 of the fitting connector 14. This decompressive direction of rotation of the torque fitting 12 may continue along the threaded body portion 28 of the fitting connector 14 until the threaded body portion 16 of the torque fitting 12 is released from its connection with the threaded body portion 28 of the fitting connector 14.

The releasable connection between the torque fitting 12 and the fitting connector 14 established with the rotation of the threaded body portion 16 of the torque fitting 12 in the compressive direction of rotation along the threaded body portion 28 of the fitting connector 14 aligns the respective channels 20, 30 of the torque fitting 12 and the fitting connector 14. Thereby, the releasably connected torque fitting 12 and fitting connector 14 align the optical fibers 24 accommodated by the respective channels 20, 30. The releasably connected torque fitting 12 and fitting connector 14 align the optical fibers 24 along an optical path 38. This optical path 38 generally is parallel with the respective longitudinal axes 22, 32 of the torque fitting 12 and the fitting connector 14.

In addition, the releasably connected torque fitting 12 and fitting connector 14 align the optical fibers 24 such that their respective ends 36 are in a proximity sufficient to permit transmission of light across the optical fibers 24. In one embodiment, the ends 36 of the optical fibers 24 are aligned such that there is no air gap, or other gap, between the ends 36. Rather, at least a portion of the respective ends 36 are in direct contact to facilitate and substantially maximize the transmission of light across the optical fibers 24. In another embodiment, the ends 36 of the optical fibers 24 are in close proximity with a small air gap, or other gap, between the ends 36, wherein the transmission loss is less than about 0.3 decibels per kilometer.

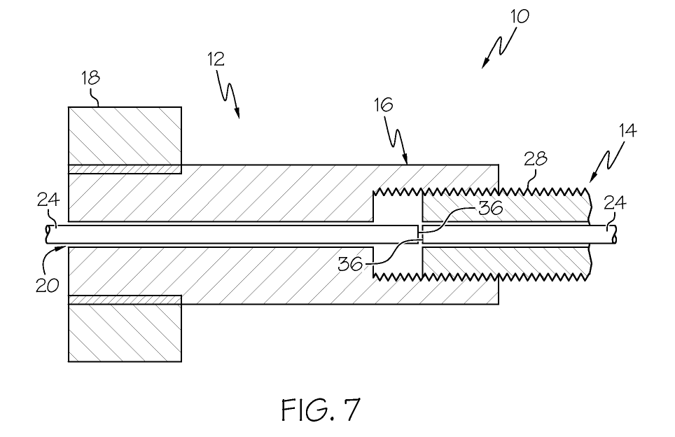

The torque fitting 12 and the fitting connector 14 may assume one of any variety of complimentary configurations sufficient to align optical fibers 24 as described herein. Further, the optical fiber connection assembly 10 may comprise at least two optical fibers 24, wherein at least one of the optical fibers 24 is accommodated by each of the respective channels 20, 30 of the torque fitting 12 and the fitting connector 14. In one embodiment, shown in FIG. 7, an end 36 of the optical fiber 24 accommodated by the channel 20, 30 of one of the torque fitting 12 and the fitting connector 14 is disposed substantially coplanar with an end of the threaded body portion 16, 28 of the one of the torque fitting 12 and the fitting connector 14, while an end 36 of the optical fiber 24 accommodated by the channel 20, 30 of the other of the torque fitting 12 and the fitting connector 14 is recessed in the channel 20, 30 from the end of the threaded body portion 16, 28 of the other of the torque fitting 12 and the fitting connector 14.

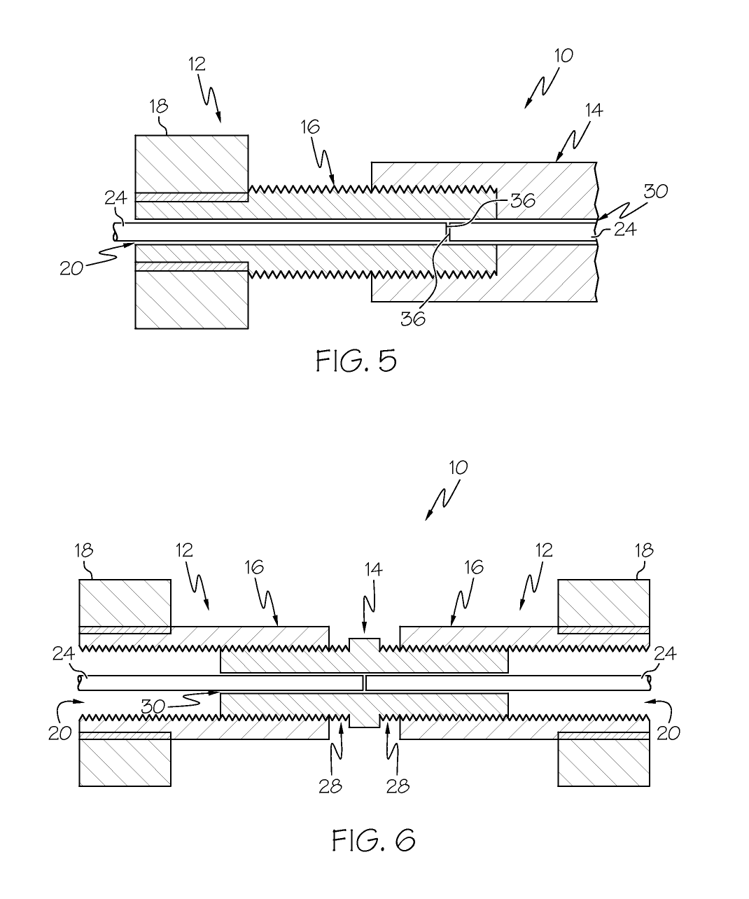

In another embodiment, an end 36 of the optical fiber 24 accommodated by the channel 20, 30 of one of the torque fitting 12 and the fitting connector 14 extends beyond an end of the threaded body portion 16, 28 of the one of the torque fitting 12 and the fitting connector 14, while an end 36 of the optical fiber 24 accommodated by the channel 20, 30 of the other of the torque fitting 12 and the fitting connector 14 is recessed in the channel 20, 30 from the end of the threaded body portion 16, 28 of the other of the torque fitting 12 and the fitting connector 14. Further, in yet another embodiment, shown in FIGS. 1 and 5, both an end 36 of the optical fiber 24 accommodated by the channel 20 of the torque fitting 12 and an end 36 of the optical fiber 24 accommodated by the channel 30 of the fitting connector 14 are recessed in the respective channel 20, 30 from the end of the respective threaded body portion 16, 28.

In another embodiment, shown in FIG. 6, the fitting connector 14 comprises at least two threaded body portions 28 disposed at opposite ends of the fitting connector 14 and at least one optical fiber accommodating channel 30 that extends along the longitudinal axis 32 of the fitting connector 14 and through the threaded body portions 28 disposed at the opposite ends of the fitting connector 14. One torque fitting 12 is releasably connected to each threaded body portion 28 disposed at the opposite ends of the fitting connector 14 such that optical fibers accommodated by the respective channels 20 of the torque fittings 12 are accommodated by the channel 30 of the fitting connector 14. More particularly, the ends 36 of the optical fibers 24 extend beyond the end of the threaded body portion 16 of the respective torque fitting 12 and are accommodated by the channel 30 of the fitting connector 14 with the releasable connection of the torque fittings 12 to the fitting connector 14.

In yet another embodiment, the fitting connector 14 is a second torque fitting comprising a mechanical thread 34 complimentary to the mechanical thread 26 of the threaded body portion 16 of the torque fitting 12. It is contemplated that generally one of the complimentary mechanical threads 26, 34 is positioned on an exterior surface of the respective threaded body portion 16, 28 of one of the torque fitting 12 and the fitting connector 14 and the other of the complimentary mechanical threads 26, 34 is positioned on an interior surface, defined by the channel 20, 30, of the respective threaded body portion 16, 28 of the other of the torque fitting 12 and the fitting connector 14. Further, it is contemplated that the complimentary mechanical threads 26, 34 may be positioned on both the exterior and interior surfaces of the respective threaded body portions 16, 28.

With each embodiment of the optical fiber connection assembly 10, regardless of the positioning of the ends 36 of the optical fibers 24 with respect to the channels 20, 30 by which the optical fibers 24 are accommodated, the ends 36 of the optical fibers 24 are aligned along an optical path 38 in a proximity sufficient to permit transmission of light across the optical fibers 24 with the achievement of the threshold level of torque applied in rotating the torque fitting 12 along the threaded body portion 28 of the fitting connector 14.

This sufficient proximity of the ends 36 of the optical fibers 24, whether in direct contact or separated by an insignificant gap, generally is achieved simultaneously, or substantially simultaneously, with the achievement of the threshold level of torque applied in rotating the torque fitting 12 in the compressive direction of rotation along the threaded body portion 28 of the fitting connector 14. Thus, the torque fitting 12 allows a user to rotate the torque-limiting body portion 18 in the compressive direction of rotation until achievement of the threshold level when the torque fitting 12 fails to force the threaded body portion 16 to rotate with the torque-limiting body portion 18 at a point where sufficient proximity between the ends of the optical fibers 24 is established without forcibly compressing the ends 36 against each other to a degree that may cause damage or misalignment. This achievement of the threshold level may be readily apparent to the user of the torque fitting 12 as a significant drop in rotational resistance in the torque-limiting body portion 18 may occur. As will be understood from the detailed description of an embodiment of the torque fitting 12 presented below, the user may also note an audible click once the threshold level, and, thus, the sufficient proximity between the optical fiber ends 36, are achieved.

Thereby, the torque-limiting configuration of the torque fitting 12 precludes an over-tightening of the torque fitting 12 in its releasable connection with the fitting connector 14 that may damage or cause misalignment of the ends 36 of the optical fibers 24 in sufficient proximity by the optical fiber connection assembly 10. Prevention of over-tightening of a torque fitting minimizes a transmission loss of light transmitted across optical fibers 24 connected by an optical fiber connection assembly 10. More specifically, prevention of over-tightening of a torque fitting 12 in its releasable connection with a fitting connector 14 avoids compression of the ends 36 of the optical fibers 24 against each other to a degree that may cause misalignment and/or damage, such as cracks, deformation, or degradation, of the optical fiber ends 36, which may increase transmission loss.

In addition, the torque-limiting configuration of the torque fitting 12 avoids an under-tightening of the torque fitting 12 in its releasable connection with the fitting connector 14, which may result in the presence of a significant air gap between the ends 36 of the optical fibers 24, by permitting tightening of the releasable connection to achievement of the threshold level of torque, at which point further tightening of the releasable connection is prevented. Protection against under-tightening of a torque fitting minimizes a transmission loss of light transmitted across optical fibers 24 connected by an optical fiber connection assembly 10. More particularly, protection against under-tightening of a torque fitting in its releasable connection with a fitting connector 14 avoids the presence of a significant air gap, or other-filled gap, between the ends 36 of the optical fibers 24 aligned with the optical fiber connection assembly 10, which may result in increased transmission loss with a greater amount of light spill-over of the optical core of the receiving end and/or a reflection of the light by the air, or other matter, in the gap.

Thereby, the torque-limiting configuration of the optical fiber connection assembly 10 controls the amount of torque applied in connecting the ends 36 of the optical fibers 24 connected by the assembly 10 and ensures that the optical fiber ends 36 are aligned along an optical path 38 in a proximity sufficient to transmit a light across the optical fibers 24 with minimal transmission loss. This torque-limiting configuration of the optical fiber connection assembly 10 can be provided in one of any variety of ways.

One embodiment of the torque-limiting configuration of the optical fiber connection assembly 10, specifically, the torque fitting 12, is illustrated in FIGS. 2-4. The threaded body portion 16 of the torque fitting 12 comprises a lever 40 and the torque-limiting body portion 18 comprises an abutment 42. The lever 40 comprises a first arresting surface 44 and a yielding surface 46, while the abutment 42 comprises a second arresting surface 48 and an engaging surface 50. Referring to FIG. 2, the yielding surface 46 and the engaging surface 50 are configured to engage such that when torque below the threshold level is applied to the torque-limiting body portion 18, the engagement of the yielding surface 46 and the engaging surface 50 forces the threaded body portion 16 to rotate with the torque-limiting body portion 18. This condition remains until the sufficient proximity between the ends 36 of the optical fibers 24 accommodated by the torque fitting 12 and the fitting connector 14 to which the torque fitting 12 is releasably connected is established, at which time the threshold level is achieved and the abutment 42 deflects the lever 40.

More particularly, as is illustrated in FIGS. 2 and 3, the engaging surface 50 contacts the yielding surface 46 and deflects the lever 40 when torque is applied in rotating the torque-limiting body portion 18 in the compressive direction of rotation along the threaded body portion 28 of the fitting connector 14. In the illustrated embodiment, this deflection of the lever 40 by the abutment 42 causes the lever 40 to flex toward the threaded body portion 16 of the torque fitting 12 and away from the torque-limiting body portion 18. The degree of this deflection will vary depending upon the torque applied in rotating the torque-limiting body portion 18 in the compressive direction of rotation. FIG. 2 illustrates a condition where the degree of deflection is minimal and, as such, the torque-limiting body portion 18 will force the threaded body portion 16 to rotate with it in the compressive direction of rotation. FIG. 3, meanwhile, illustrates a condition where the amount of torque applied to the torque-limiting body portion 18 has reached or exceeded a threshold level of torque. Under this condition, the torque-limiting body portion 18 will not force the threaded body portion 16 to rotate with it in the compressive direction of rotation because the lever 40 deflects an amount sufficient to allow the lever 40 to bypass abutment 42. Thereby, the threaded body portion 16 of the torque fitting 12 no longer rotates along the threaded body portion 28 of the fitting connector 14 and the torque-limiting body portion 18 rotates substantially freely around the threaded body portion 16 in the compressive direction of rotation once the lever 40 has bypassed the abutment 42. The lever 40 is preferably provided with a degree of elasticity that is sufficient to enable repetitive deflection of the lever 40.

The torque fitting 12 is configured such that the amount of torque necessary to achieve the threshold level, and, thus, to position the optical fiber ends 36 in sufficient proximity, are established by the size and shape of the abutment 42 and the size, shape, and rigidity of the lever 40. Specific examples of means for tailoring the degree of torque that can be applied to the threaded body portion are given below. However, it is noted that those practicing the present invention should appreciate that a wide array of lever and abutment characteristics can be configured to tailor the amount of torque that can be applied in rotating the threaded body portion 16 in the compressive direction of rotation.

For example, the rigidity of the lever, which can be a function of many factors (composition, size, shape, orientation, thickness, etc.), can be tailored to determine the amount of torque that can be applied to the threaded body portion 16 via the torque-limiting body portion 18. The less rigid the configuration of the lever 40, the lower the threshold level of torque applied. The more rigid the configuration of the lever 40, the higher the threshold level of torque applied. Once the threshold level of torque is exceeded, the engagement between the yielding surface 46 and the engaging surface 50 is lost such that the lever 40 bypasses the abutment 42 and no further rotation of the threaded body portion 16 in the compressive direction of rotation is permitted.

As a further example, the degree to which the abutment 42 protrudes from the otherwise uniform surface of the body portion carrying the abutment 42 and the degree to which the yielding surface 44 of the lever 40 extends into the corresponding depth dimension defined by the abutment 42 can also be tailored to determine the amount of torque that can be applied to the threaded body portion 16. As described above, a given degree of deflection is required for the lever 40 to bypass the abutment 42. Those practicing the present invention can configure the torque fitting 12 to permit application of a relatively large degree of torque by providing a relatively large abutment 42 and configuring the lever 40 to protrude a relatively large extent into the depth defined by the abutment. In contrast, a smaller abutment 42 or a smaller lever protrusion will permit application of a relatively low degree of torque.

As shown in FIG. 4, the engagement of the first and second arresting surfaces 62, 72 forces the threaded body portion 16 to rotate with the torque-limiting body portion 18 when the torque-limiting body portion 18 rotates in the decompressive direction of rotation. Stated differently, the first and second arresting surfaces 62, 72 are configured to arrest relative rotation between the threaded body portion 16 and the torque-limiting body portion 18 when the arresting surfaces 62, 72 are engaged. Thereby, the threaded body portion 16 of the torque fitting 12 rotates in the decompressive direction of rotation along the threaded body portion 28 of the fitting connector 14 and may continue in this rotation until the torque fitting 12 is released from its connection with the fitting connector 14.

In describing an embodiment of the present invention, reference is made to a torque fitting 12 comprising a lever 40 and an abutment 42, wherein the lever 40 may bypass the abutment 42. This recitation should not be taken to require that the torque-limiting body portion 18 comprises the lever 40. Rather, the bypass condition is merely utilized herein to relate to a condition of relative motion between the lever 40 and abutment 42, when a threshold level of torque is reached, without regard to which body portion 16, 18 comprises the lever 40. It is further contemplated by embodiments of the present invention that the threaded body portion 16 may comprise the abutment 42, while the torque-limiting body portion 18 may comprise the lever 40. Embodiments of the present invention also contemplate that a body portion 16, 18 of the torque fitting 12 may comprise more than one lever 40, while the other body portion 16, 18 of the torque fitting 12 may comprise more than one abutment 42.

As used herein, “optical fiber” refers to a transparent, or relatively transparent, medium that transmits light across a length of the medium. The medium typically, but not necessarily, is a silica glass fiber that generally confines the transmitted light to an inside of the fiber to arrival at an end of the transmitting fiber. The optical fibers referred to herein may be a single optical fiber, a group of optical fibers, a bundle of groups of optical fibers, or any combination thereof. Further, as used herein, “sufficient proximity,” when used to describe a relationship between ends of optical fibers, refers to a direct contact between at least a portion of the ends of the optical fibers or to ends of optical fibers separated by a gap insufficient to interfere with a transmission of light as described herein.

It is noted that recitations herein of a component of an embodiment being “configured” in a particular way or to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that terms like “generally” and “typically,” when utilized herein, are not utilized to limit the scope of the claimed embodiments or to imply that certain features are critical, essential, or even important to the structure or function of the claimed embodiments. Rather, these terms are merely intended to identify particular aspects of an embodiment or to emphasize alternative or additional features that may or may not be utilized in a particular embodiment.

For the purposes of describing and defining embodiments herein it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described embodiments of the present invention in detail, and by reference to specific embodiments thereof, it will be apparent that modifications and variations are possible without departing from the scope of the embodiments defined in the appended claims. More specifically, although some aspects of embodiments of the present invention are identified herein as preferred or particularly advantageous, it is contemplated that the embodiments of the present invention are not necessarily limited to these preferred aspects.

What is claimed is:

1. A method of aligning optical fibers, wherein the method comprises:
providing a torque fitting comprising a threaded body portion, a torque-limiting body portion, and an optical fiber accommodating channel, wherein the threaded body portion of the torque fitting comprises a mechanical thread defining a compressive direction of rotation and a decompressive direction of rotation and the torque-limiting body portion and the threaded body portion of the torque fitting are configured such that,
below a threshold level of torque applied to the torque-limiting body portion, rotation of the torque-limiting body portion in the compressive direction of rotation forces the threaded body portion of the torque fitting to rotate with the torque-limiting body portion,
above the threshold level of torque applied to the torque-limiting body portion, rotation of the torque-limiting body portion in the compressive direction of rotation fails to force the threaded body portion to rotate with the torque-limiting body portion, and
rotation of the torque-limiting body portion in the decompressive direction of rotation forces the threaded body portion to rotate with the torque-limiting body portion;
providing a fitting connector comprising a threaded body portion and an optical fiber accommodating channel, wherein the threaded body portion of the fitting connector comprises a mechanical thread complimentary to the mechanical thread of the threaded body portion of the torque fitting;
inserting an optical fiber at least partially into the optical fiber accommodating channel of the torque fitting;
inserting an optical fiber at least partially into the optical fiber accommodating channel of the fitting connector; and
connecting the respective threaded body portions of the torque fitting and the fitting connector by rotating the threaded body portion of the torque fitting along the threaded body portion of the fitting connector such that an end of the optical fiber accommodated by the fiber accommodating channel of the fitting connector and an end of the optical fiber accommodated by the fiber accommodating channel of the torque fitting are aligned along an optical path in a proximity sufficient to permit transmission of light across the optical fibers with achievement of the threshold level of torque applied in rotating the torque fitting along the threaded body portion of the fitting connector, whether the ends of the optical fibers are in direct contact or are separated by a gap.

2. The method of claim 1, wherein the proximity of the optical fibers aligned along the optical path is sufficient to permit transmission of light across the optical fibers with a transmission loss of less than about 0.3 decibels per kilometer.

3. The method of claim 2, wherein the torque fitting and fitting connector are configured such that direct contact between respective ends of the optical fibers is initiated when the threshold level of torque is applied in rotating the torque fitting in the compressive direction of rotation along the threaded body portion of the fitting connector.

4. An optical fiber connection assembly comprising a torque fitting and a fitting connector, wherein:
the torque fitting comprises a threaded body portion, a torque-limiting body portion, and an optical fiber accommodating channel;
the threaded body portion of the torque fitting comprises a mechanical thread defining a compressive direction of rotation and a decompressive direction of rotation;
the torque-limiting body portion and the threaded body portion are configured such that,
below a threshold level of torque applied to the torque-limiting body portion, rotation of the torque-limiting body portion in the compressive direction of rotation forces the threaded body portion of the torque fitting to rotate with the torque-limiting body portion,
above the threshold level of torque applied to the torque-limiting body portion, rotation of the torque-limiting body portion in the compressive direction of rotation fails to force the threaded body portion to rotate with the torque-limiting body portion, and
rotation of the torque-limiting body portion in the decompressive direction of rotation forces the threaded body portion to rotate with the torque-limiting body portion;
the fitting connector comprises a threaded body portion and an optical fiber accommodating channel;
the threaded body portion of the fitting connector comprises a mechanical thread complimentary to the mechanical thread of the threaded body portion of the torque fitting; and
the respective threaded body portions of the torque fitting and the fitting connector are connectable by rotating the threaded body portion of the torque fitting along the threaded body portion of the fitting connector such that an end of an optical fiber accommodated by the fiber accommodating channel of the torque fitting is aligned with an optical fiber accommodated by the fiber accommodating channel of the fitting connector along an optical path in a proximity sufficient to permit transmission of light across the optical fibers with achievement of the threshold level of torque applied in rotating the torque fitting along the threaded body portion of the fitting connector, whether the ends of the optical fibers are in direct contact or are separated by a gap.

5. The assembly of claim 4, wherein the torque fitting and fitting connector are configured such that the proximity of the optical fibers aligned along the optical path is sufficient to permit transmission of light across the optical fibers with a transmission loss of less than about 0.3 decibels per kilometer.

6. The assembly of claim 5, wherein the torque fitting and fitting connector are configured such that direct contact between respective ends of the optical fibers is initiated when the threshold level of torque applied in rotating the torque fitting in the compressive direction of rotation along the threaded body portion of the fitting connector.

7. The assembly of claim 4, wherein the assembly further comprises an optical fiber accommodated by the fiber accommodating channel of the torque fitting and an optical fiber accommodated by the fiber accommodating channel of the fitting connector.

8. The assembly of claim 7, wherein the torque fitting and fitting connector are configured such that:
an end of the optical fiber accommodated by the channel of one of the torque fitting and the fitting connector is disposed substantially coplanar with an end of the threaded body portion of the one of the torque fitting and the fitting connector, and
an end of the optical fiber accommodated by the channel of the other of the torque fitting and the fitting connector is recessed in the channel from the end of the threaded body portion of the other of the torque fitting and the fitting connector.

9. The assembly of claim 8, wherein the torque fitting and fitting connector are configured such that the proximity of the optical fibers aligned along the optical path is sufficient to permit transmission of light across the optical fibers with a transmission loss of less than about 0.3 decibels per kilometer.

10. The assembly of claim 8, wherein the torque fitting and fitting connector are configured such that direct contact between respective ends of the optical fibers is initiated when the threshold level of torque is applied in rotating the torque fitting in the compressive direction of rotation along the threaded body portion of the fitting connector.

11. The assembly of claim 4, wherein the fitting connector comprises a second torque fitting.

12. The assembly of claim 4, wherein the fitting connector comprises at least two threaded body portions disposed at opposite ends of the fitting connector and at least one optical fiber accommodating channel that extends along the longitudinal axis of the fitting connector through the opposite ends of the fitting connector.

13. The assembly of claim 12, wherein one torque fitting is releasably connected to each of the threaded body portion disposed at the opposite ends of the fitting connector such that optical fibers accommodated by the respective channels of the torque fittings are accommodated by the channel of the fitting connector and aligned along the optical path in a proximity sufficient to permit transmission of light across the optical fibers with achievement of the threshold level of torque applied in rotating the torque fittings in the compressive direction of rotation along the threaded body portions of the fitting connector.

14. The assembly of claim 13, wherein the torque fitting and fitting connector are configured such that the proximity of the optical fibers aligned along the optical path is sufficient to permit transmission of light across the optical fibers with a transmission loss of less than about 0.3 decibels per kilometer.

15. The assembly of claim 4, one of the complimentary mechanical threads is positioned on an exterior surface of the respective threaded body portions of the torque fitting and the fitting connector and the other of the complimentary mechanical threads is positioned on an interior surface of the respective threaded body portions of the torque fitting and the fitting connector.

16. An optical fiber connection assembly comprising a torque fitting and a fitting connector, wherein:
the torque fitting comprises a threaded body portion, a torque-limiting body portion, and an optical fiber accommodating channel;
one of the threaded body portion or the torque-limiting body portion comprises a lever;
the other of the threaded body portion or the torque-limiting body portion comprises an abutment;
the lever comprises a first arresting surface and a yielding surface;
the abutment comprises a second arresting surface and an engaging surface;
the lever and the abutment are configured such that the yielding surface of the lever and the engaging surface of the abutment engage when torque below a threshold level is applied in rotating the torque-limiting body portion in a compressive direction of rotation;
the lever and the abutment are further configured such that the engaging surface contacts the yielding surface and the lever deflects an amount sufficient to allow the lever to bypass the abutment when torque above the threshold level is applied in rotating the torque-limiting body portion in the compressive direction of rotation;
the deflection of the lever by the abutment causes the lever to flex toward the body portion of the torque fitting comprising the lever and away from the body portion of the torque fitting comprising the abutment;
the lever is configured with a degree of elasticity sufficient to enable repetitive flexion of the lever;
the lever and the abutment are further configured such that the first and second arresting surfaces engage when torque is applied in rotating the torque-limiting body portion in a decompressive direction of rotation such that the torque-limiting body portion forces the threaded body portion of the torque fitting to rotate with the torque-limiting body portion;
the fitting connector comprises a threaded body portion and an optical fiber accommodating channel;
the threaded body portion of the fitting connector comprises a mechanical thread complimentary to the mechanical thread of the threaded body portion of the torque fitting; and
the respective threaded body portions of the torque fitting and the fitting connector are connectable by rotating the threaded body portion of the torque fitting along the threaded body portion of the fitting connector the such that an end of an optical fiber accommodated by the fiber accommodating channel of the torque fitting is aligned with an end of an optical fiber accommodated by the fiber accommodating channel of the fitting connector along an optical path in a proximity sufficient to permit transmission of light across the optical fibers with achievement of the threshold level of torque applied in rotating the torque fitting along the threaded body portion of the fitting connector, whether the ends of the optical fibers are in direct contact or are separated by a gap.
